(19) United States
(12) Patent Application Publication
(10) Pub. No.: US 2024/0294042 A1
(43) Pub. Date: Sep. 5, 2024

(54) TIRE-REPAIRING CONNECTOR

(71) Applicant: U-POWER COLLECTION ENTERPRISE CO., LTD., Taichung City (TW)

(72) Inventor: Perry TSAI, Taichung City (TW)

(21) Appl. No.: 18/455,455

(22) Filed: Aug. 24, 2023

(30) Foreign Application Priority Data
Mar. 2, 2023 (TW) 112107662

(51) Int. Cl. B60C 25/00; B29C 73/08; B60S 5/04

(52) U.S. Cl. CPC B60C 25/16; B29C 73/08; B60S 5/04

(57) ABSTRACT

A tire-repairing connector includes a main body and an insertion tube. The main body has a connecting end and a second end. The main body is provided therein with a gas inlet channel extending through the connecting end. The insertion tube is provided with a gas passage therein. One end of the insertion tube is provided in the second end of the main body, with the gas passage in communication with the gas inlet channel. The other end of the insertion tube is a pointed end with a clamping groove having an opening. The clamping groove is configured to hold a tire plug. The insertion tube and the tire plug held in the clamping groove can be inserted into a puncture in a tire to repair the puncture, and the tire can be inflated directly through the tire-repairing connector.

### BACKGROUND OF THE INVENTION

### 1. Technical Field

The present invention relates to a bicycle tool and more particularly to a tire-repairing connector for tire repair.

### 2. Description of Related Art

It seems inevitable that a bicycle rider will run over a sharp object and end up having a punctured tire. Therefore, it is common practice for a bicycle rider to carry a tire repair tool and a bicycle pump or tire-inflating gas cartridge with them, in order to repair a puncture in a tire with the tire repair tool, and inflate the repaired tire with the bicycle pump or tire-inflating gas cartridge through the valve of the tire.

During the aforesaid tire repairing and inflating process, the tire repair tool serves only to repair the puncture in the tire and cannot be used to inflate the tire, so tire repair and tire inflation must be carried out separately at different positions on the tire, which is inconvenient.

### BRIEF SUMMARY OF THE INVENTION

One objective of the present invention is to provide a tire-repairing connector that not only can be used to repair a puncture in a tire, but also can work with a tire-inflating gas cartridge to inflate the tire, thereby allowing tire repair and tire inflation to be completed rapidly.

The tire-repairing connector provided by the present invention includes a main body and an insertion tube;
the main body has two ends, one of the two ends is a connecting end for connecting with a tire-inflating gas cartridge, the other end of the main body is defined as a second end; the main body is provided therein with a gas inlet channel that extends through the connecting end; and
the insertion tube is a hollow tube with a gas passage provided therein, one end of the insertion tube is provided in the second end of the main body, with the gas passage in communication with the gas inlet channel; the other end of the insertion tube is a pointed end. The pointed end is provided with a clamping groove that has an opening.

The foregoing design is such that the clamping groove of the insertion tube can hold a tire plug, that the tire plug can repair a puncture in a tire when inserted into the puncture along with the insertion tube, and that a tire-inflating gas cartridge can be subsequently connected to the connecting end of the main body, in order for the gas in the tire-inflating gas cartridge to flow into the tire through the gas inlet channel and the gas passage and thereby inflate the tire, and consequently for tire repair and tire inflation to be completed at one time at the same spot to save time and effort. The insertion tube is pulled out of the tire when the tire is fully inflated.

In one embodiment, the pointed end has an inclined surface and the pointed end forms a high edge and a low edge, with a height difference between the two edges, and the opening of the clamping groove is located at the high edge.

In one embodiment, the clamping groove has a middle section, and the middle section has the smallest width of the clamping groove.

In one embodiment, the clamping groove has two walls that curve toward each other such that the middle section of the clamping groove has the smallest width of the clamping groove.

In one embodiment, the second end of the main body is provided with a coupling portion, and the tire-repairing connector further includes a cylindrical body. The coupling portion can be coupled to one end of the cylindrical body in a detachable manner such that the insertion tube is received in the cylindrical body.

In one embodiment, the connecting end of the main body is provided with a second coupling portion, and the second coupling portion can be coupled to the aforesaid end of the cylindrical body in a detachable manner.

In one embodiment, the connecting end of the main body is provided with an internal hole portion that forms a part of the gas inlet channel. One end of a tire-inflating gas cartridge can be coupled to the internal hole portion in a detachable manner.

In one embodiment, the connecting end of the main body is protrudingly provided with a bridging portion, and the gas inlet channel extends through the bridging portion. The bridging portion can be coupled to one end of an adapter.

### BRIEF DESCRIPTION OF THE SEVERAL VIEWS OF THE DRAWINGS

The objectives, features, and intended effects of the present invention can be better understood by referring to the following detailed description of some preferred embodiments in conjunction with the accompanying drawings, in which:

FIG. 1 is a perspective view of the tire-repairing connector according to the first preferred embodiment of the invention;

FIG. 2 is another perspective view of the tire-repairing connector according to the first preferred embodiment of the invention;

FIG. 3 is a rear view of the tire-repairing connector in FIG. 1;

FIG. 4 is a longitudinal sectional view taken along line 4-4 in FIG. 1;

FIG. 5 is a perspective view showing the tire-repairing connector in FIG. 1 and a cylindrical body coupled together to form a tire-repairing device;

FIG. 6 is an exploded perspective view of the tire-repairing device in FIG. 5;

FIG. 7 is a longitudinal sectional view taken along line 7-7 in FIG. 5;

FIG. 8 shows the tire-repairing connector being used to repair a tire;

FIG. 9 shows the tire-repairing connector working with a tire-inflating gas cartridge to inflate a tire;

FIG. 10 is a sectional view of a tire-repairing device formed by coupling the tire-repairing connector according to the second preferred embodiment of the invention to a cylindrical body;

FIG. 11 shows the tire-repairing connector in FIG. 10 being used to repair a tire;

FIG. 12 shows the tire-repairing connector in FIG. 10 being used to inflate a tire;

FIG. 13 is a perspective view of the tire-repairing connector according to the third preferred embodiment of the invention;

FIG. 14 is a longitudinal sectional view taken along line 14-14 in FIG. 13;

FIG. 15 is a perspective view of a tire-repairing device formed by coupling the tire-repairing connector in FIG. 13 to a cylindrical body;

FIG. 16 is an exploded perspective view of the tire-repairing device in FIG. 15;

FIG. 17 is a longitudinal sectional view taken along line 17-17 in FIG. 15;

FIG. 18 shows the tire-repairing connector in FIG. 13 being used to repair a tire;

FIG. 19 shows the tire-repairing connector in FIG. 13 working with a tire-inflating gas cartridge to inflate a tire;

FIG. 20 shows another example of use of the tire-repairing connector in FIG. 13; and

FIG. 21 is a sectional view of the assembly in FIG. 20.

### DETAILED DESCRIPTION OF THE INVENTION

The present invention provides a tire-repairing connector for use as a tire repair tool to not only repair but also inflate a tire. The tire-repairing connector 10 in each of the following embodiments has a main body 20 and an insertion tube 30.

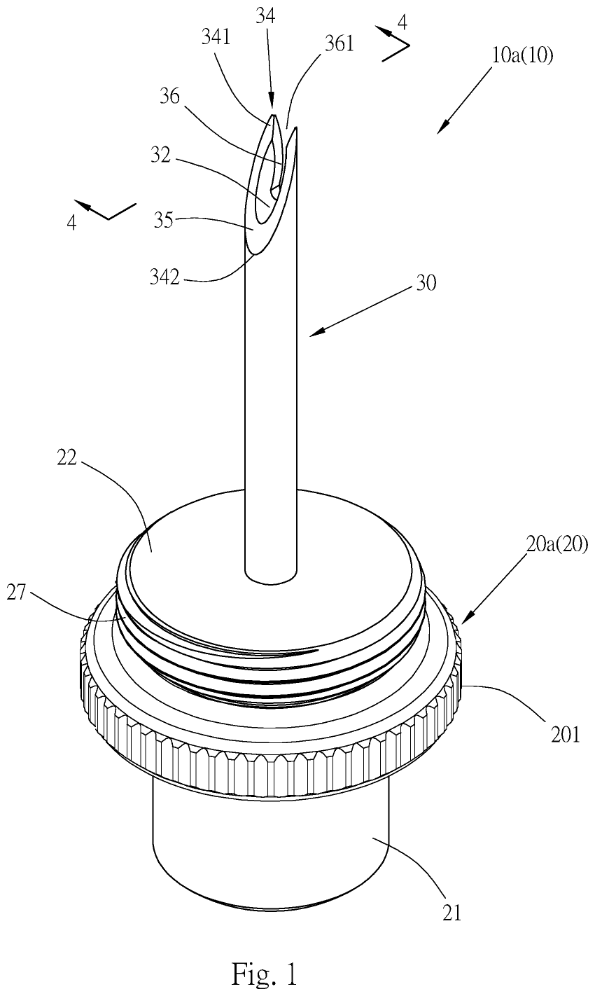

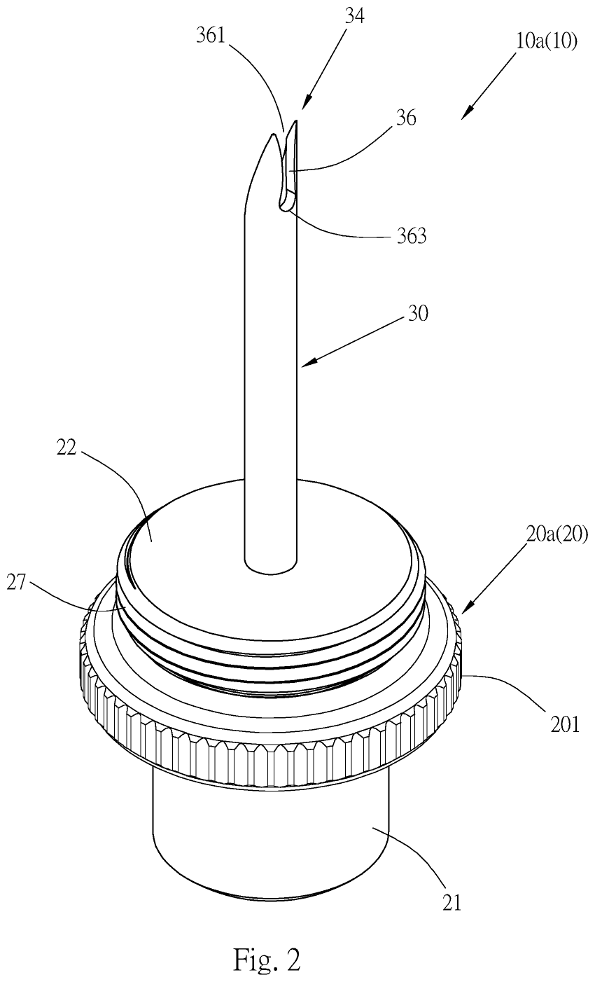

Referring to FIG. 1 to FIG. 4, the tire-repairing connector 10a (10) provided by the first preferred embodiment of the present invention includes a main body 20a and an insertion tube 30.

The main body 20a has two ends. The first end of the main body 20a is a connecting end 21 and has a gas inlet channel 23. One end of the gas inlet channel 23 extends through the connecting end 21 of the main body 20a. An internal hole portion 24 is provided in the connecting end 21 of the main body 20a, has an internal thread, and forms a part of the gas inlet channel 23. A puncturing portion 25 and a packing ring 26 are provided in the gas inlet channel 23. A coupling portion 27 is provided at the second end 22 of the main body 20a. The coupling portion 27 in this embodiment is an external thread provided on the outer periphery of the second end 22. The main body 20a has a relatively large large-diameter portion 201 located between the first end and the second end to make it easy for a user to rotate the tire-repairing connector.

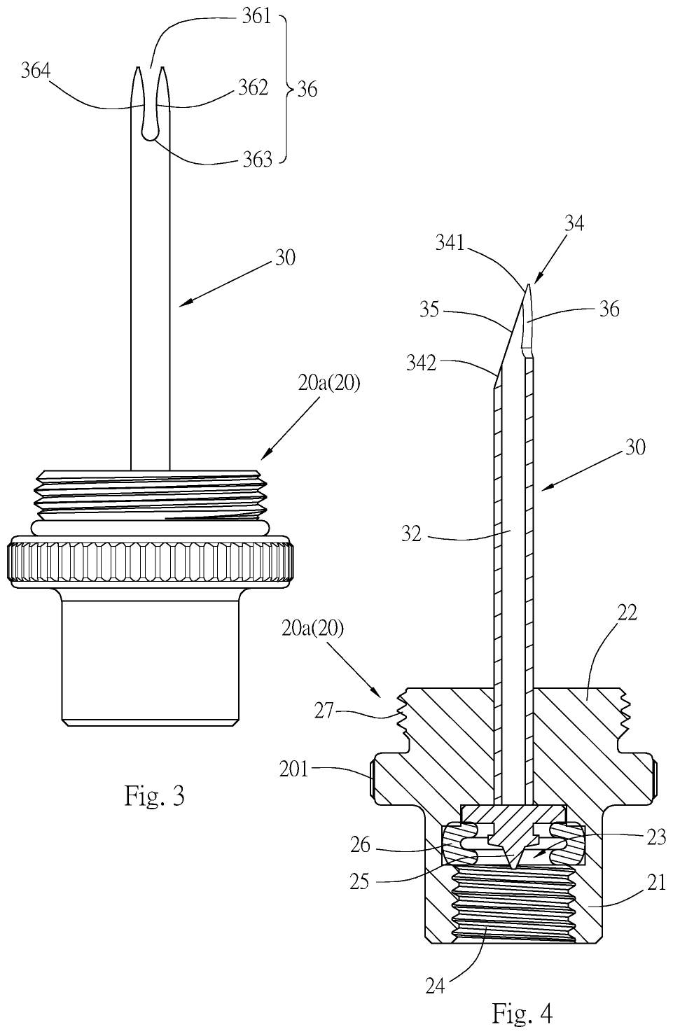

The insertion tube 30 is a hollow tube and is provided therein a gas passage 32 that opens at the two ends of the insertion tube 30. One end of the insertion tube 30 is provided in the second end 22 of the main body 20a such that the inner end of the gas passage 32 is in communication with the gas inlet channel 23. The other end (i.e., the free end) of the insertion tube 30 is a pointed end 34. A clamping groove 36 is provided at the pointed end 34 and has an opening 361. The pointed end 34 has an inclined surface 35 and thus forms a high edge 341 and a low edge 342, which two edges have a difference in height. The low edge 342 is closer to the main body 20a than is the high edge 341. The opening 361 of the clamping groove 36 is located at the high edge 341. Referring to FIG. 3, the two walls 364 of the clamping groove 36 curve toward each other such that a middle section 362 of the clamping groove 36 has the smallest width of the clamping groove 36. That is to say, the width of the middle section 362 is smaller than those of the closed end 363 and the opening 361 of the clamping groove 36.

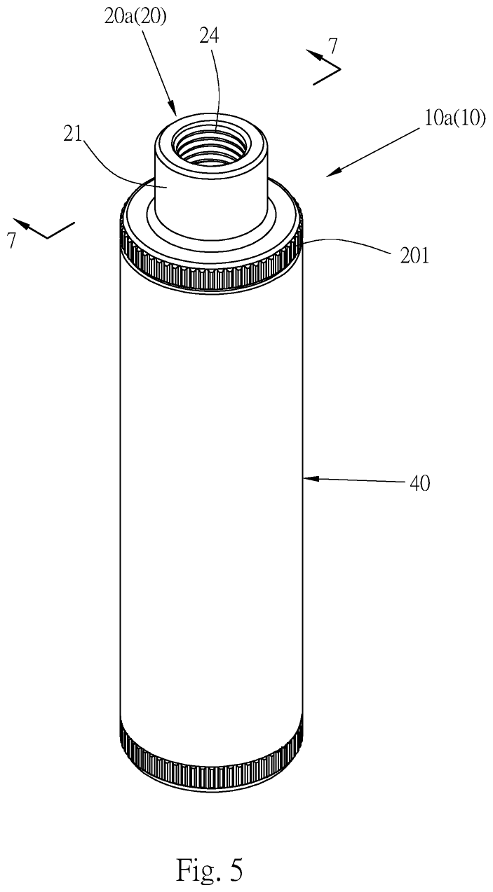

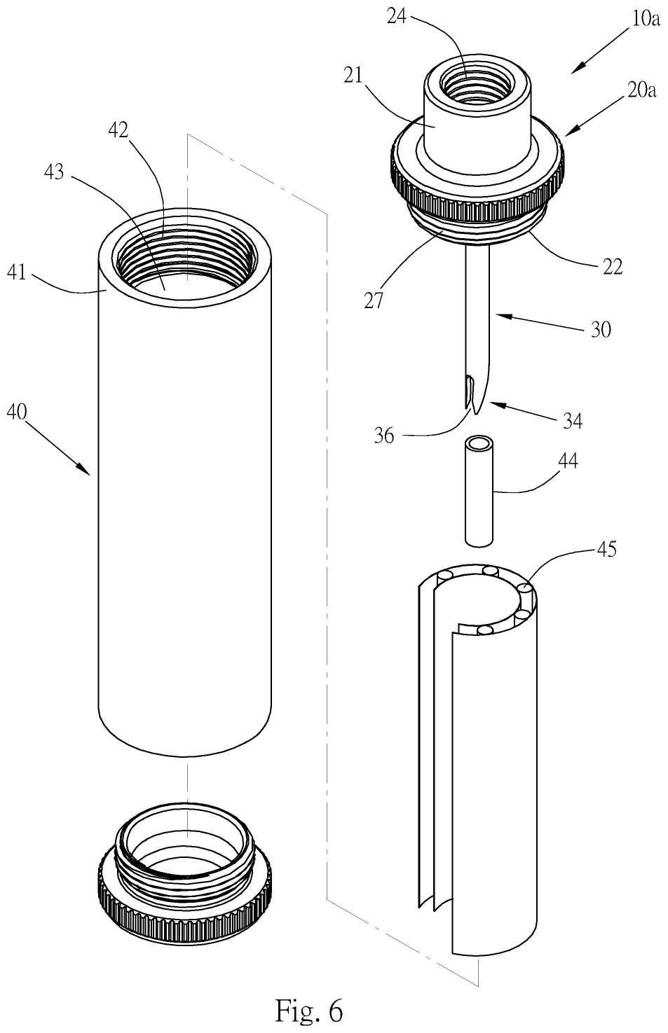

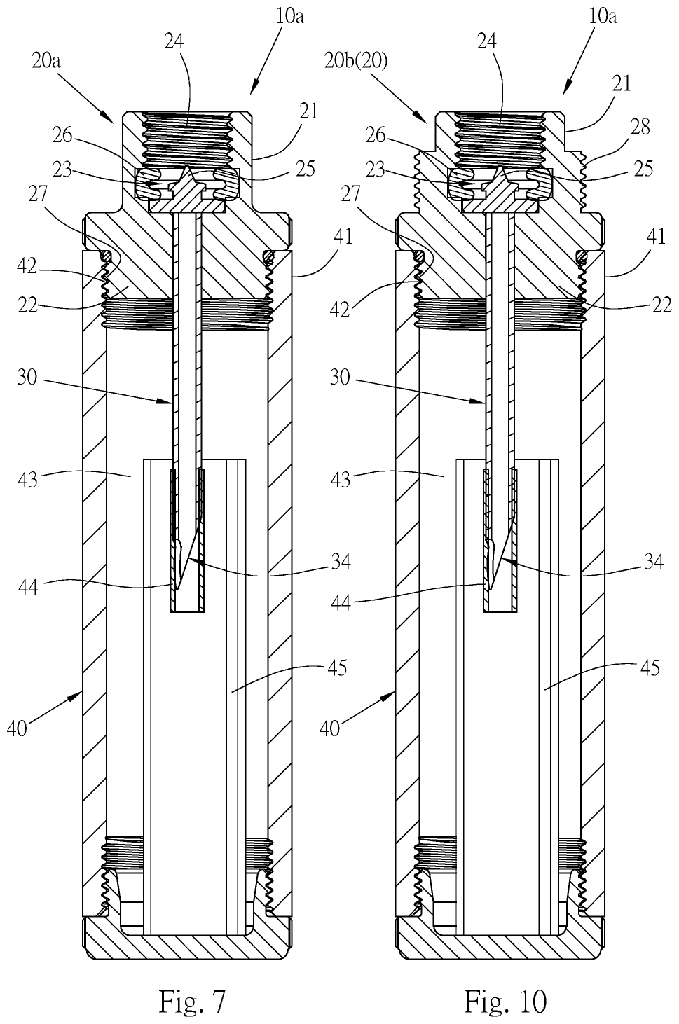

Referring to FIG. 5 to FIG. 7, the tire-repairing connector 10a can be received in a hollow cylindrical body 40, with the coupling portion 27 of the second end 22 of the main body threadedly connected to the threaded portion 42 at one end 41 of the cylindrical body 40 and thus the tire-repairing connector 10a is coupled to the cylindrical body 40 in a separable manner. The insertion tube 30 in that case is received in a receiving space 43 of the cylindrical body 40, with a flexible cover 44 mounted around the pointed end 34. A plurality of tire plugs 45 can also be received in the receiving space 43.

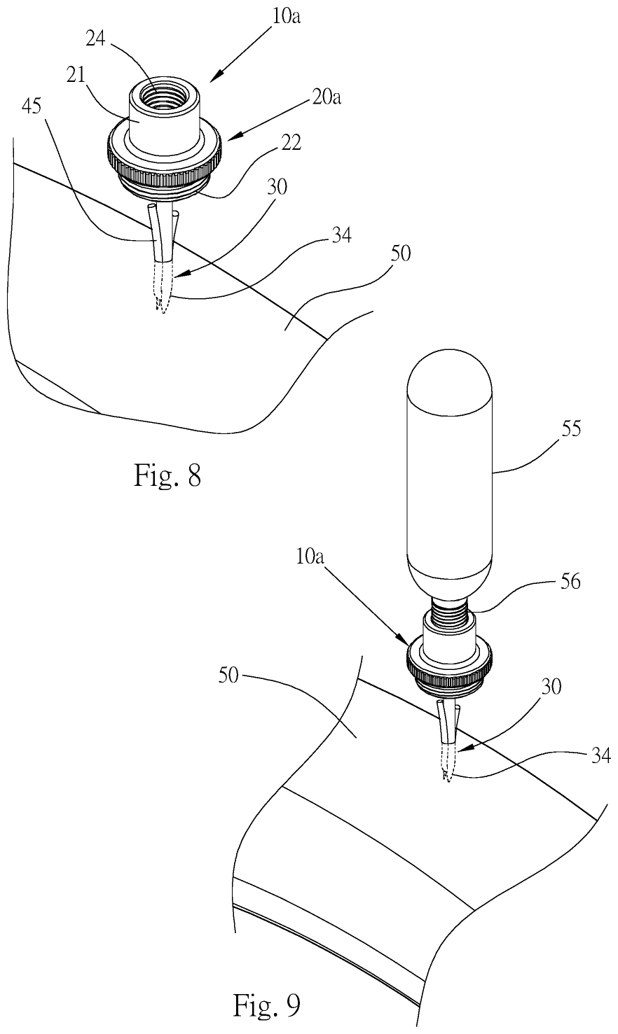

When a tire is punctured by a foreign object and needs repairing, the user of the tire-repairing connector 10a may push a tire plug 45 through the opening 361 into the clamping groove 36 of the insertion tube 30, passing through the middle section 362, until the tire plug 45 is held at the closed end 363 of the clamping groove 36. Then, referring to FIG. 8, the user inserts the pointed end 34 of the insertion tube 30 into the puncture in the tire 50 together with the tire plug 45 in order for the tire plug 45 to fill and seal the puncture.

Once the insertion tube 30 is inserted into the tire 50, one end of the gas passage 32 is in communication with the internal space of the tire 50, so the user continues by threadedly connecting the threaded connection end 56 of a tire-inflating gas cartridge 55, which contains a high-pressure gas, to the internal hole portion 24 of the connecting end 21 of the main body 20a, as shown in FIG. 9. During the process, the puncturing portion 25 pierces through the sealing membrane of the gas cartridge 55 such that the high-pressure gas in the gas cartridge flows through the gas inlet channel 23 of the main body 20a into the gas passage 32 of the insertion tube 30 and enters the tire 50 through the outer end of the gas passage 32 to inflate the tire. When the tire is fully inflated, the insertion tube 30 is pulled out of the tire 50 to complete the tire repairing and inflating operation. The tire-repairing connector of the present invention makes it possible to repair and inflate a punctured tire directly at the puncture, thereby providing convenience of operation.

FIG. 10 shows that the tire-repairing connector 10b according to the second preferred embodiment of the present invention can be coupled to a hollow cylindrical body 40 in a detachable manner to form a tire-repairing device, with the insertion tube 30 received in the receiving space 43 of the cylindrical body 40. The tire-repairing connector 10b in this embodiment has the same overall structure as its counterpart in the first preferred embodiment. Identical parts in these two embodiments can be recognized by the use of identical reference numerals and will not be described repeatedly.

The tire-repairing connector 10b is different from the tire-repairing connector 10a in the first embodiment only in that the outer periphery of the connecting end 21 of the main body 20b is provided with a second coupling portion 28. The second coupling portion 28 is a thread having the same outer diameter as the coupling portion 27 provided at the second end 22 of the main body 20.

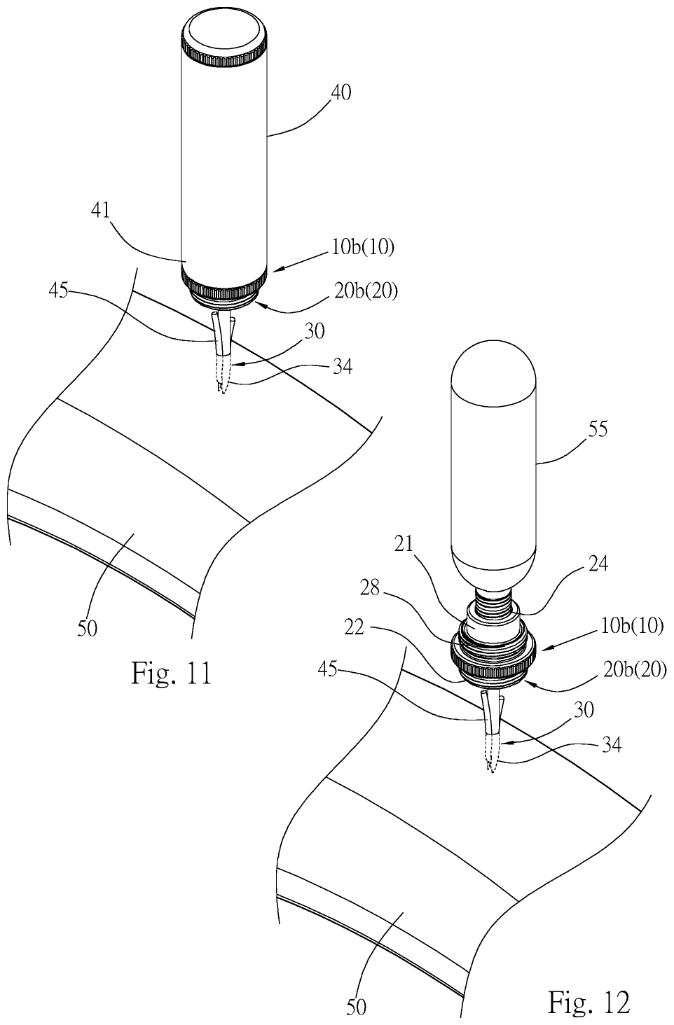

To repair a tire 50, referring to FIG. 11, the second coupling portion 28 of the connecting end of the main body 20b is threadedly connected to the threaded portion 42 at the end 41 of the cylindrical body 40 such that the cylindrical body 40 becomes a handle of the tire-repairing connector. The user of the tire-repairing connector, therefore, can hold the cylindrical body 40 while inserting the insertion tube 30 and a tire plug 45 into the tire 50. After the insertion, referring to FIG. 12, the cylindrical body 40 is removed, and a tire-inflating gas cartridge 55 is connected to the internal hole portion 24 of the connecting end 21 of the main body 20b to inflate the tire. When the tire is fully inflated, the insertion tube 30 is pulled out of the tire.

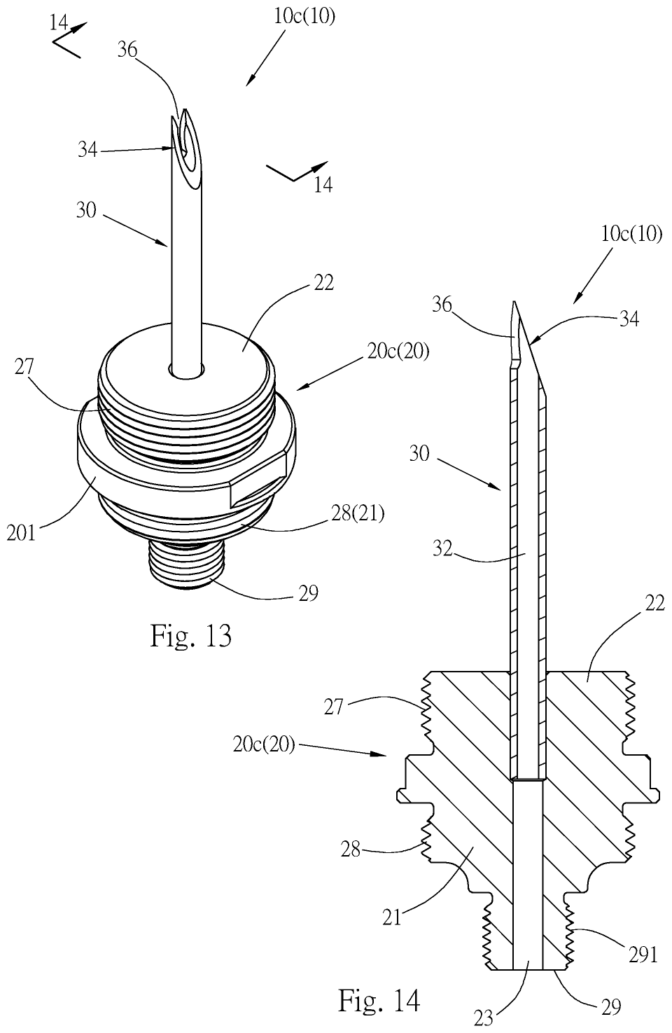

FIG. 13 and FIG. 14 show the tire-repairing connector 10c according to the third preferred embodiment of the present invention. As in the previous embodiments, the tire-repairing connector 10c includes a main body 20c and an insertion tube 30.

The connecting end (i.e., the first end) 21 of the main body 20c is provided therein with a gas inlet channel 23 extending through the connecting end 21. A second coupling portion 28 is provided at the connecting end. More specifically, the second coupling portion 28 is an external thread provided on the outer periphery of the connecting end 21. A coupling portion 27 is provided at the second end 22 of the main body and is an external thread.

The end face of the connecting end 21 of the main body 20c is further provided with a bridging portion 29. The bridging portion 29 in this embodiment is a portion having a smaller outer diameter than the second coupling portion 28 and is a post protruding outward from the connecting end 21. A thread 291 is provided on the outer periphery of the bridging portion 29. The gas inlet channel 23 extends through the connecting end 21 and the bridging portion 29.

The insertion tube 30 has the same structure as its counterpart in the first preferred embodiment and can be understood from the first embodiment. Identical parts of the insertion tubes in the two embodiments are indicated by identical reference numerals.

One end of the insertion tube 30 is fixedly provided in the second end 22 of the main body 20c such that the gas passage 32 is in communication with the gas inlet channel 23 in the connecting end 21.

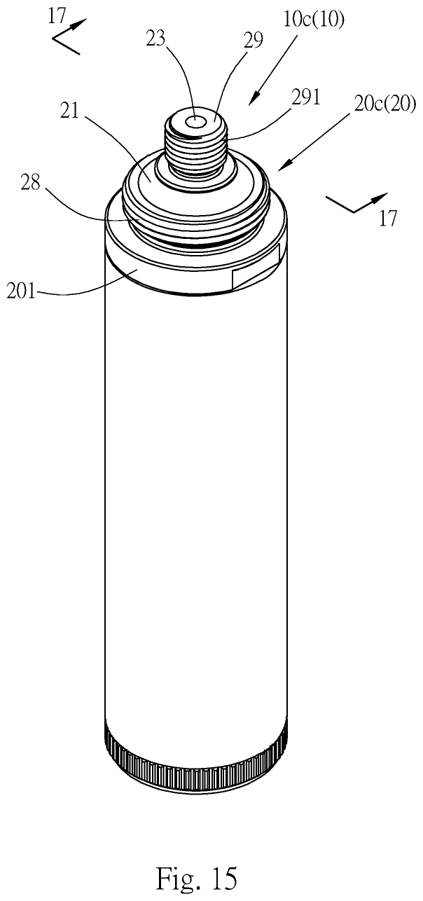

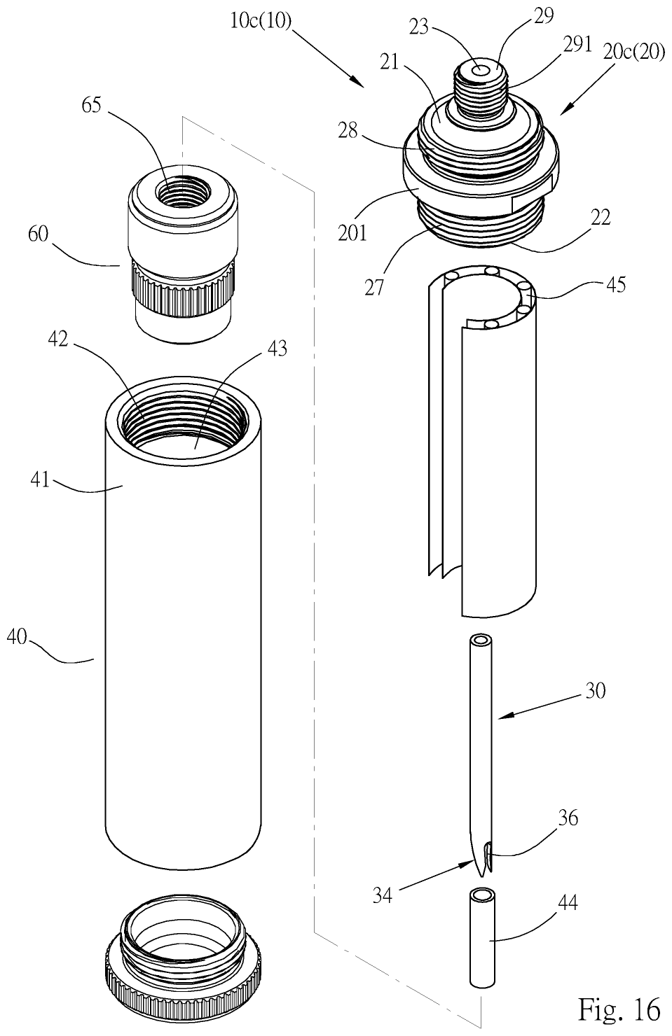

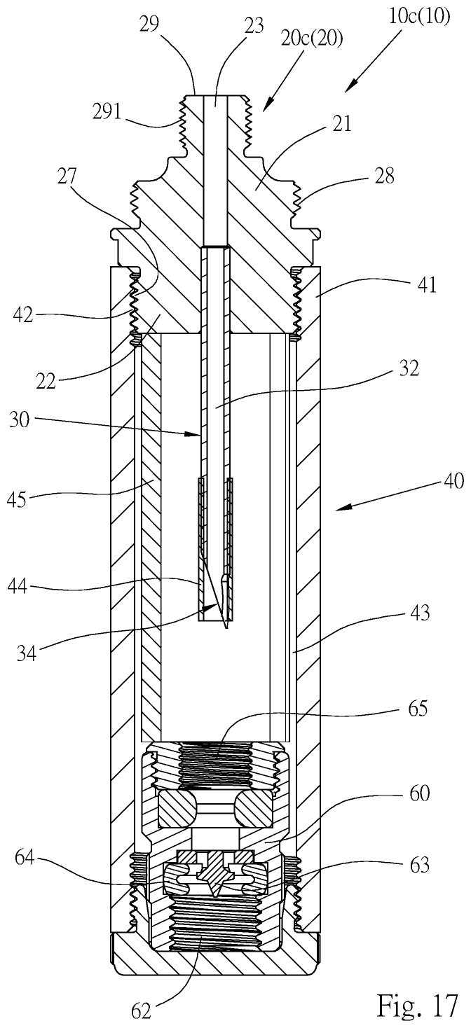

Referring to FIG. 15 to FIG. 17, the tire-repairing connector 10c can be received in a hollow cylindrical body 40, with the coupling portion 27 of the second end 22 of the main body 20c threadedly connected to the threaded portion 42 at the end 41 of the cylindrical body 40 and thus coupled to the cylindrical body 40 in a separable manner. The insertion tube 30 in that case will be received in a receiving space 43 of the cylindrical body 40, with a flexible cover 44 mounted around the pointed end 34. A plurality of tire plugs 45 can be received in the receiving space 43 as well.

An adapter 60 can also be received in the receiving space 43 and can be taken out of the receiving space 43 when needed. The adapter 60 is provided with a gas cartridge connecting hole 62 at one end and a connecting hole 65 at the opposite end. The two connecting holes 62 and 65 are in communication with each other. A puncturing portion 63 and a packing ring 64 are provided in the gas cartridge connecting hole 62. The gas cartridge connecting hole 62 is configured to connect with a tire-inflating gas cartridge, and the puncturing portion 63 is configured to pierce through the sealing membrane of the tire-inflating gas cartridge.

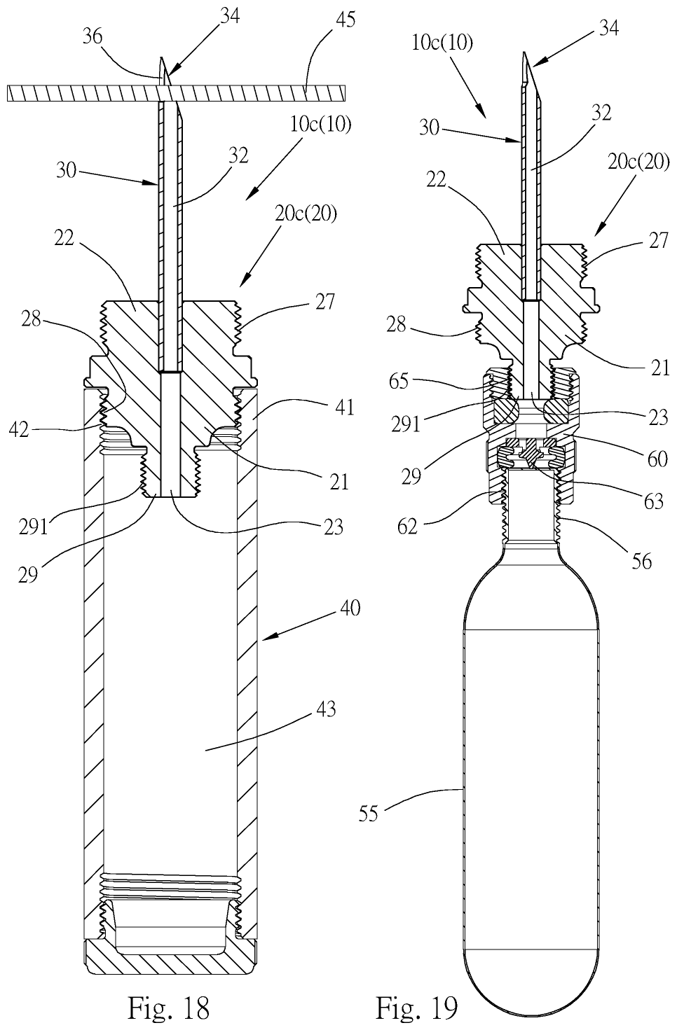

To repair a tire 50, referring to FIG. 18, a tire plug 45 is pushed into the clamping groove 36 of the insertion tube 30, and the second coupling portion 28 of the connecting end 21 of the main body 20c is threadedly connected to the threaded portion 42 at the end 41 of the cylindrical body 40. Then, holding the cylindrical body 40, the user inserts the insertion tube 30 and the tire plug 45 into the tire 50. After that, referring to FIG. 19, the cylindrical body 40 is removed, the connecting hole 65 of the adapter 60 is threadedly connected to the bridging portion 29 of the connecting end 21 of the main body 20c, and a tire-inflating gas cartridge 55 is connected to the gas cartridge connecting hole 62 of the adapter 60 to inflate the tire 50.

In this embodiment, the bridging portion 29 has the same outer diameter as a Schrader, Presta, or English tire valve, and the connecting hole 65 is threadedly connectable to the bridging portion 29 or a tire valve. The adapter 60, therefore, makes it possible to inflate a tire through the tire valve using a tire-inflating gas cartridge. To inflate a tire in this way, the connecting hole 65 is coupled to the tire valve, and the gas cartridge connecting hole 62 is coupled to the tire-inflating gas cartridge.

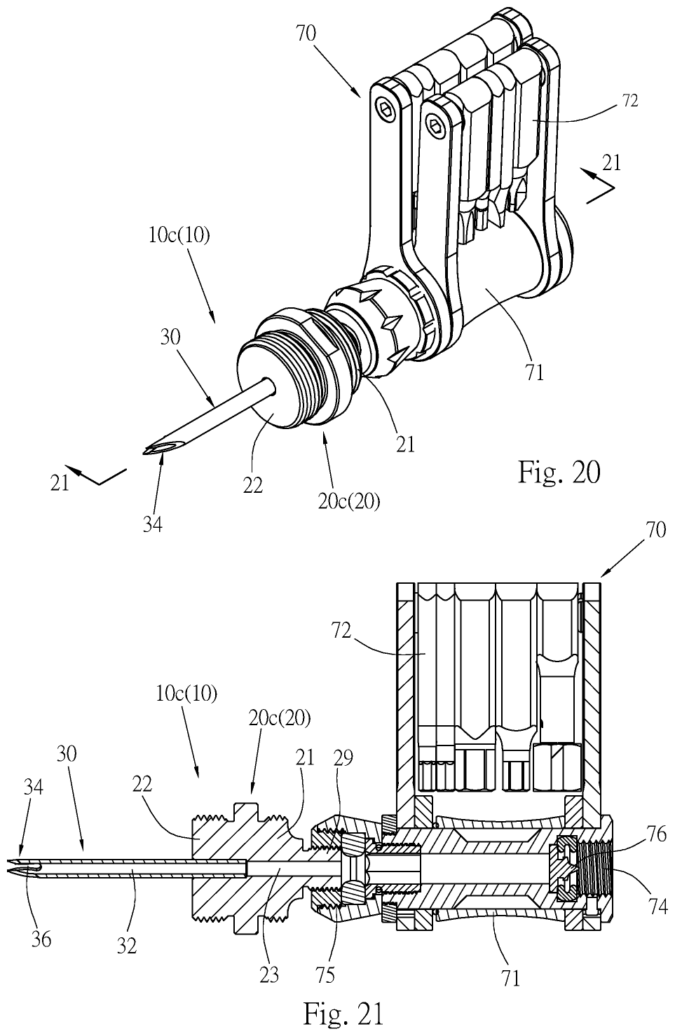

FIG. 20 and FIG. 21 show an example of using the tire-repairing connector 10c together with a bicycle tool kit 70. The bicycle tool kit 70 has a main body 71 and a plurality of bicycle tools 72. A gas cartridge connecting hole 74 is provided at one end of the main body 71, and a connecting hole 75 at the opposite end of the main body 71. The two connecting holes 74 and 75 are in communication with each other. A puncturing portion 76 is provided in the gas cartridge connecting hole 74. The bridging portion 29 of the main body 20c is connected to the connecting hole 75, and a tire-inflating gas cartridge can be connected to the gas cartridge connecting hole 74 in order to inflate a punctured tire after the puncture is repaired.

The tire-repairing connector 10 of the present invention can be used to repair a punctured tire and then inflate the tire through the insertion tube 30 directly at the puncture, thereby reducing the effort and time required for repairing and inflating the tire.

Although the invention has been disclosed as above with the embodiments, it is not intended to limit the invention. A person having ordinary skill in the art to which the invention pertains can make various changes and modifications without departing from the spirit and scope of the invention. Therefore, scope of protection of the invention shall be subject to what is defined in the pending claims.

What is claimed is:

1. A tire-repairing connector, comprising:
a main body having two ends, one end of the two ends being a connecting end, the other end of the two ends being a second end, a gas inlet channel being provided in the main body and extending through the connecting end; and
an insertion tube configured as a hollow tube with two ends, a gas passage being provided in the insertion tube, one end of the insertion tube being provided in the second end of the main body, with the gas passage in communication with the gas inlet channel, the other end of the insertion tube being a pointed end, the pointed end being provided with a clamping groove, and the clamping groove having an opening.

2. The tire-repairing connector of claim 1, wherein the pointed end of the insertion tube has an inclined surface and thus the pointed end forms a high edge and a low edge, with a height difference between the high edge and the low edge, and the opening of the clamping groove is located at the high edge.

3. The tire-repairing connector of claim 1, wherein the clamping groove has a middle section, and the middle section has a smallest width of the clamping groove.

4. The tire-repairing connector of claim 2, wherein the clamping groove has a middle section, and the middle section has a smallest width of the clamping groove.

5. The tire-repairing connector of claim 3, wherein the clamping groove has two walls curving toward each other such that the middle section of the clamping groove has the smallest width of the clamping groove.

6. The tire-repairing connector of claim 1, wherein the second end of the main body is provided with a coupling portion, the tire-repairing connector further comprises a cylindrical body, and the coupling portion is configured to be coupled to one end of the cylindrical body in a detachable manner.

7. The tire-repairing connector of claim 6, wherein the connecting end of the main body is provided with a second coupling portion, and the second coupling portion is configured to be coupled to the end of the cylindrical body in a detachable manner.

8. The tire-repairing connector of claim 1, wherein the connecting end of the main body is provided with an internal hole portion forming a part of the gas inlet channel.

9. The tire-repairing connector of claim 1, wherein the connecting end of the main body is protrudingly provided with a bridging portion, and the gas inlet channel extends through the bridging portion.
